(19) United States
(12) Patent Application Publication
(10) Pub. No.: US 2003/0097716 A1
(43) Pub. Date: May 29, 2003

(54) Wire cut, strip and crimp tool

(76) Inventor: William F. Nordlin, Poplar Grove, IL (US)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/305,211

(22) Filed: Nov. 26, 2002

Related U.S. Application Data
(60) Provisional application No. 60/334,302, filed on Nov. 29, 2001.

(51) Int. Cl. B25F 1/00

(52) U.S. Cl. 7/107

(57) ABSTRACT

A tool is provided which can be used for cutting, stripping and crimping different types and sizes of wires. The tool has long jaws which are capable of receiving and retaining a plurality of inserts for performing functions, such as cutting, stripping and crimping. The inserts are retained in the jaws by spring loaded pins and fixed pins. The tool has a mechanism which provides for a full cycle crimp mode and for a cut/strip mode. The mechanism includes a member which is capable of preventing a spring biased pawl from engaging with a toothed link, connected between the handles of the tool, which forces the user to complete a crimp; and capable of preventing the pawl from engaging the toothed link, thus allowing the free movement of the handles.

### CROSS-REFERENCE

This patent application claims the benefit of domestic priority of U.S. Provisional Application Serial No. 60/334,302, filed Nov. 29, 2001, and entitled “Wire Cut, Strip And Crimp Tool”.

### BACKGROUND OF THE INVENTION

The present invention relates to a tool for cutting, stripping and crimping wire.

There are a plurality of hand tools on the market which are used to cut, strip and crimp solid and stranded wire from 10-24 gauge. An electrician needs a number of these tools to perform a variety of tasks, i.e., a hand tool to cut wire, a hand tool to strip wire, and a hand tool to crimp wire. The tools that the electrician uses also may not have the capability of cutting, stripping, or crimping different types and or sizes of wires. Thus, the electrician must have a plurality of these tools at his/her disposal.

The electrician, however, may not have room in his/her tool pouch for one of every type of tool that he/she needs. The requirement that the electrician have all of these types of tools also adds to the electrician's cost, the weight of the tools that the electrician must carry around, and the size of the electrician's tool pouch.

Thus, while there will always be a need for dedicated tools for specific operations, it is desirable to have a single tool that can cut, strip and crimp solid and/or stranded wire over a variety of gauges, thus allowing the electrician to reduce his/her costs, his/her tool pouch size, and the weight of the tools that the electrician must carry to perform his/her jobs. The present invention provides such a tool by providing a tool having quick change inserts, a lockout mechanism to switch the tool from a cut/strip mode to a full cycle crimp mode, and long jaws to provide room for cutter, plier jaws, and strip and/or crimp functions.

### OBJECTS AND SUMMARY OF THE INVENTION

A primary object of the invention is to provide a tool that is capable of accepting and retaining a plurality of different types of inserts which would allow the hand tool to cut, strip or crimp different types and sizes of wires.

Another primary object of the invention is to provide a tool that has a lockout mechanism that is used to switch the hand tool from a cut/strip mode to a full cycle crimp mode.

An object of the invention is to provide a tool which has long jaws to provide room for cutter, plier jaws and strip and/or crimp features.

Another object of the invention is to provide a single tool which will reduce the amount of money an electrician would have to spend to have the appropriate tools to cut, strip and crimp different types and sizes of wires.

Yet another object of the invention is to provide a single tool which will cut, strip and crimp different types and sizes of wires, thus reducing the weight of tools within an electrician's tool pouch and the size of the electrician's tool pouch.

Still another object of the invention is to provide a tool which will allow an electrician to quickly install and uninstall a plurality of different types of inserts therein which will allow the tool to either cut, strip or crimp different types and sizes of wires.

Briefly, and in accordance with the foregoing, a novel tool is provided which can be used for cutting, stripping and crimping different types and sizes of wires. The tool has long jaws which are capable of receiving and retaining a plurality of inserts for performing functions, such as cutting, stripping and crimping. The inserts are retained in the jaws by spring loaded pins and fixed pins. The tool further has a mechanism which provides for a full cycle crimp mode and for a cut/strip mode. The mechanism includes a member which is capable of preventing a spring biased pawl from engaging with a toothed link, connected between the handles of the tool, which forces the user to complete a crimp; and capable of preventing the pawl from engaging the toothed link, thus allowing the free movement of the handles.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a side elevational view of a tool which incorporates the features of the present invention with the handles of the tool in an open position; and

FIG. 2 is a side elevational view of the tool illustrated in FIG. 1, with the tool being partially shown in cross-section.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

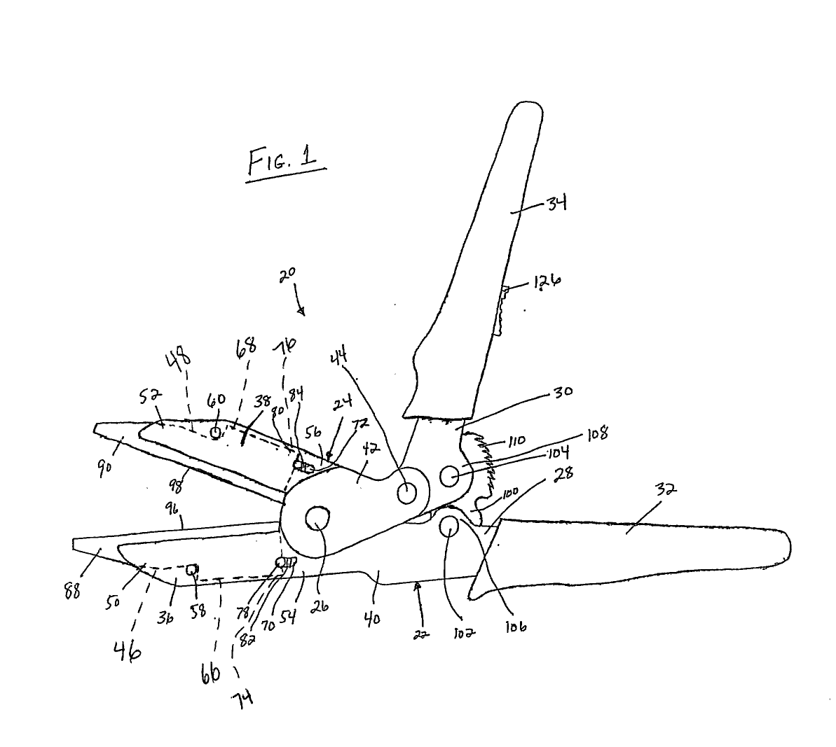

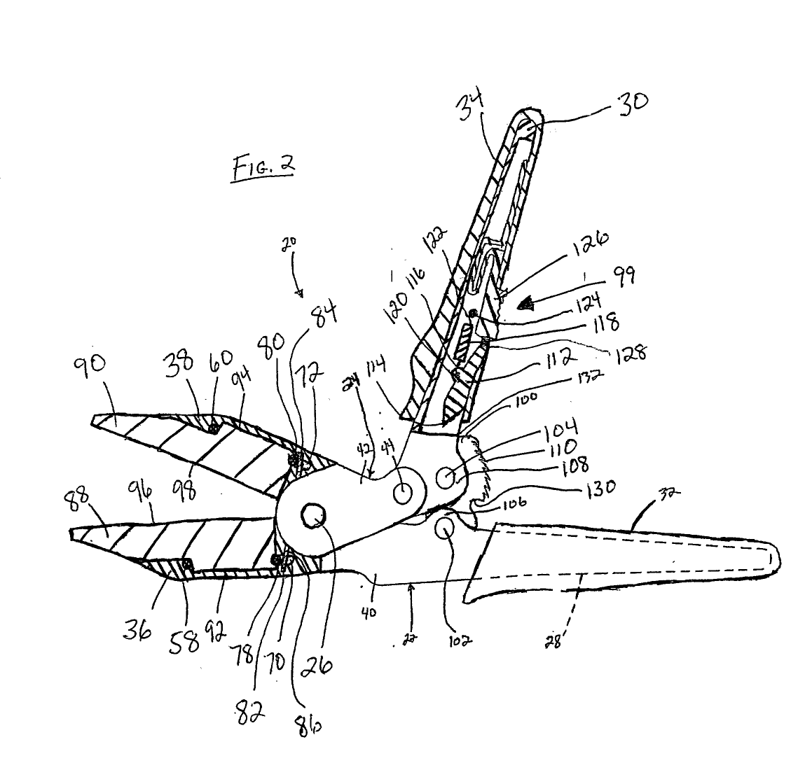

A tool 20, illustrated in FIGS. 1 and 2, is used to cut, strip and crimp wire, such as solid and stranded wire, from 10-24 gauge. The tool 20 includes a pair of arms 22, 24. Each arm 22, 24 has first and second opposite ends and are fastened together at a hinge joint 26 along the length of the arms 22, 24 such that the arms 22, 24 can be brought proximate to each other or can be spread apart from each other by rotation around the hinge joint 26.

A handle 28, 30 is provided at the respective first end of each arm 22, 24. The handles 28, 30 both respectively have grips 32, 34 provided thereon to allow a user's hand(s) to more easily hold onto the tool 20 when the tool 20 is being actuated by the user. A jaw 36, 38 is provided at the respective second end of each arm 22, 24. Jaw 36 is connected to handle 28 by a connection portion 40. Jaw 38 is connected to handle 30 by a connection portion 42. The hinge joint 26 hingedly connects the connection portions 40, 42 together.

With regard to arm 22, the handle 28 is on one side of the hinge joint 26 and the jaw 36 is on the other side of the hinge joint 26. The arm 22 is preferably integrally formed such that the handle 28, the connection portion 40 and the jaw 36 are all formed from a single piece of material.

With regard to arm 24, the handle 30 is on one side of the hinge joint 26 and the jaw 38 is on the other side of the hinge joint 26. The arm 24 is preferably formed such that the handle 30, the connection portion 42 and the jaw 38 are all formed as separate pieces of material. The connection portion 42 and the handle 30 are hingedly connected to each other at hinge joint 44 while connection portion 42 and jaw 38 are fixedly connected to each other by suitable means, although connection portion 42 and jaw 38 could be integrally formed.

The jaws 36, 38 have cavities 46, 48 provided therein, respectively. The cavities 46, 48 extend from the first free ends 50, 52 of the jaws 36, 38 to the second ends 54, 56 of the jaws 36, 38, which are proximate to the connection of the jaws 36, 38 to the connection portions 40, 42. The cavities 46, 48 face one another such that the cavities 46, 48 open to the space provided between the jaws 36, 38 when the jaws 36, 38 are positioned apart from one another.

The jaws 36, 38, respectively, have fixed pins 58, 60 extending therethrough at a position between the first end 50, 52 and the second end 54, 56 of the jaws 36, 38. The fixed pins 58, 60 are inserted into the jaws 36, 38 or the fixed pins 58, 60 are molded into the jaws 36, 38. The fixed pins 58, 60 are positioned proximate to a first end 62, 64 of a base 66, 68 of the cavities 46, 48.

The jaws 36, 38 have slots 70, 72 extending therethrough proximate to the second ends 54, 56 thereof. The slots 70, 72 are positioned at a second end 74, 76 of the base 66, 68 of the cavities 46, 48 and are in communication with the respective cavity 46, 48. Pins 78, 80 extend through the slots 70, 72 and are capable of moving within the slots 70, 72. The pins 78, 80 are biased toward the center of the respective cavity 46, 48 by a torsion spring 86. The torsion spring 86 is positioned around the hinge joint 26 and its respective ends 82, 84 engage against the pins 78, 80.

The cavities 46, 48 are capable of accepting a plurality of different inserts, for example inserts 88, 90, shown in FIGS. 1 and 2. Each insert 88, 90 has a base portion 92, 94 and a work portion 96, 98, with the base portions 92, 94 having a length that is smaller than the work portions 96, 98. The work portions 96, 98 can be configured for cutting, stripping or crimping different types and sizes of wire. The base portions 92, 94 are inserted into the respective cavities 46, 48 and positioned between the fixed pins 58, 60 and the pins 78, 80. The work portions 96, 98 of the inserts 88, 90 extend beyond the first ends 50, 52 of the jaws 36, 38. The work portions 96, 98 of the inserts 88, 90 also extend further into the space provided between the jaws 36, 38 when the jaws 36, 38 are positioned apart from one another than do the jaws 36, 38 themselves. The jaws 36, 38 have an extended length such that a plurality of different sizes of inserts can be retained within the jaws 36, 38 to accommodate all desired sizes and types of wire to be cut, stripped and/or crimped.

A mechanism 99 is provided which allows the tool 20 to be placed in either a full cycle crimp mode or in a cut/strip mode, depending on the function which the electrician requires of the tool 20. The mechanism 99 generally includes a link 100, a pawl 112, a spring 118, and a lockout member 126.

The handles 28, 30 are connected to each other, proximate to the connection portions 40, 42, by the link 100. The link 100 is connected to the handle 28 at hinge connection 102 and the link 100 is connected to the handle 30 at hinge connection 104 which is spaced from hinge connection 102. The hinge connections 102, 104 are provided on the handles 28, 30 at rounded portions 106, 108 of the handles 28, 30 such that the rounded portions 106, 108 of the handles 28, 30 can rotate relative to one another. The link 100 has a plurality of teeth 110 provided thereon which are positioned between the handles 28, 30 and which face away from hinge joint 44. The teeth 110 are sloped in one direction toward the handle 30.

The pawl 112 is pivotally mounted within a cavity in the handle 30. The pawl 112 is formed from plastic and has a first end 114, a second end 128, and a middle portion 120 therebetween. The first end 114 of the pawl 112 is capable of engaging with the teeth 110 of the link 100 and, as the teeth 110 are sloped in one direction toward the handle 30, the teeth 110 hold the first end 114 of the pawl 112, thus preventing backward movement of the link 100 once the first end 114 of the pawl 112 has engaged the teeth 110.

The spring 118 is provided within the cavity of the handle 30. A first end 116 of the spring 118 is attached to the middle portion 120 of the pawl 112, while a second end 122 of the spring 118 is attached to a fixed pin 124, which is provided in the cavity of the handle 30. The spring 118 biases the first end 116 of the pawl 112 toward the teeth 110 of the link 100.

The lockout member 126, preferably formed from plastic, is provided within the cavity of the handle 30. The member 126 is capable of sliding within the handle 30 and can be slid to two different positions within the handle 30. In the first position, the member 126 is positioned proximate to the second end 128 of the pawl 112, but does not come into contact with the second end 128 of the pawl 112. When the member 126 is in the first position, the first end 114 of the pawl 112 is capable of engaging the teeth 110 of the link 100. In the second position, the member 126 comes into contact with the second end 128 of the pawl 112, pushing the second end 128 of the pawl 112 toward the handle 28 and, thus, preventing the first end 114 of the pawl 112 from engaging with the teeth 110 of the link 100. The member 126 can be of the sliding type, as illustrated in FIG. 2, but could also be a rotating member or a stepped pin, similar to a gun safety.

Operation of the tool 20 is now discussed. Depending on the operation for which the user wishes to use the tool 20, the user will select appropriate inserts 88, 90 having either a cutting work portion 96, 98, a stripping work portion 96, 98, or a crimping work portion 96, 98, to insert into the jaws 36, 38 of the tools 20.

To retain the inserts 88, 90 into the jaws 36, 38, the base portions 92, 94 of the inserts 88, 90 are inserted into the cavities 46, 48 of the jaws 36, 38 such that one end of each base portion 92, 94 abuts against the pins 78, 80. When the force of the ends 82, 84 of the torsion spring 86 is overcome by the base portions 92, 94 of the inserts 88, 90 pushing against the pins 78, 80, the pins 78, 80 slide within the slots 70, 72, allowing opposite ends of the base portions 92, 94 of the inserts 88, 90 to clear the fixed pins 58, 60. Once the opposite ends of the base portions 90, 92 of the inserts 88, 90 clear the fixed pins 58, 60, the user allows the spring force of the torsion spring 86 to act on the pins 78, 80 by releasing his/her grip on the inserts 88, 90, thus, allowing the pins 78, 80 to slide within the slots 70, 72, forcing the ends of the base portions 92, 94 of the inserts 88, 90 to abut against the fixed pins 58, 60. The inserts 88, 90 are then retained within the cavities 46, 48 of the jaws 36, 38 and will remain in position.

To remove the inserts 88, 90, the user pushes the inserts 88, 90 toward the hinge connection 26. The pins 78, 80 move toward the hinge connection 26, compressing the torsion spring 86. When the inserts 88, 90 have cleared the fixed pins 58, 60, the inserts 88, 90 can be rotated toward the opposing jaws 36, 38 and removed. It should be noted that a single insert could be removed or inserted without removing or inserting the other insert.

After the user has inserted the desired inserts 88, 90 into the jaws 36, 38 of the tool 20, the user must then decide whether to put the tool 20 into a cut/strip mode or a full cycle crimp mode.

Should the user elect to have the tool 20 in a cut/strip mode, the user begins by moving the member 126 on the handle 30 to its second position in which the member 126 engages the second end 116 of the pawl 112. In the second position, the member 126 overcomes the force of the spring 118 and moves the second end 128 of the pawl 112 in a clockwise direction, as viewed in FIG. 2, such that the first end 114 of the pawl 112 cannot engage the teeth 110 of the link 100. Thus, when the user moves the handle 30 toward the handle 28, the handles 28, 30 can be freely operated open and closed like a simple pair of pliers. The moving of the handle 30 toward the handle 28, further moves the connection portion 42 at the hinge connection 44 and the hinge joint 26, such that the jaw 38 moves toward the jaw 36, allowing the inserts 88, 90 in the jaws 36, 38 to perform their desired function.

If the user desires the tool to be in a full cycle crimp mode, the user moves the member 126 to its first position such that the member 126 does not come into contact with the second end 122 of the pawl 112. Thus, when the handles 28, 30 are brought together, the first end 114 of the pawl 112 engages the sloped teeth 110 of the link 100, thus, preventing the user from stopping in the middle of a crimping cycle, as the sloped teeth 110 prevent the backward movement of the link 100 once the first end 114 of the pawl 112 has engaged the teeth 110. When the jaws 36, 38 have closed sufficiently to complete a crimp, the first end 114 of the pawl 112 clears a backside 130 of the link 100. The handles 28, 30 then open as the first end 114 of the pawl 112 is dragged backwards over the sloped teeth 110 of the link 100, as the slope of the teeth 110 prevents the first end 114 of the pawl 112 from engaging with the teeth 110. When the handles 28, 30 have opened sufficiently, the pawl 112 clears a front side 132 of the link 100 ready to begin another crimping cycle.

While a preferred embodiment of the invention is shown and described, it is envisioned that those skilled in the art may devise various modifications without departing from the spirit and scope of the foregoing description and the appended claims.

The invention is claimed as follows:

1. A tool comprising:
a pair of arms, each said arm having first and second ends and a jaw at said first end thereof, said jaw of each said arm having a cavity formed therein;
a joint for connecting said pair of arms together;
a pair of inserts, one of said inserts capable of being inserted into said cavity of one of said jaws, said other insert capable of being inserted into said cavity of said other jaw; and
means for releasably securing each said insert within said cavities of said jaws.

2. A tool as defined in claim 1, wherein each said arm has a handle at said second end thereof, said joint being positioned between said jaws and said handles of said arms such that upon moving said handles toward one another, said jaws move toward one another.

3. A tool as defined in claim 2, further including mode means for providing a full cycle crimp mode and a cut/strip mode, said mode means being provided on said handles of said arms.

4. A tool as defined in claim 1, wherein each said releasably securing means comprises a stop at a first end of said cavity, a movable pin at a second end of said cavity, and a spring positioned against said movable pin to bias said movable pin toward said stop, wherein said insert is positioned within said cavity between said stop and said movable pin to releasably secure said insert within said cavity.

5. A tool as defined in claim 4, wherein said stop is a fixed pin.

6. A tool as defined in claim 4, wherein said movable pin moves within a slot provided through said jaw, said slot being in communication with said cavity.

7. A tool as defined in claim 4, wherein said spring is a torsion spring positioned around said joint.

8. A tool as defined in claim 1, wherein each said insert has a base portion and a work portion, said base portion of each said insert capable of being inserted into said cavity of said jaws.

9. A tool as defined in claim 8, wherein said work portion of each said insert has a length which is longer than a length of said base portion of each said insert.

10. A tool as defined in claim 8, wherein said work portion of each said insert is configured for cutting a workpiece.

11. A tool as defined in claim 8, wherein said work portion of each said insert is configured for stripping a workpiece.

12. A tool as defined in claim 8, wherein said work portion of each said insert is configured for crimping a workpiece.

13. A tool as defined in claim 8, wherein said work portion of each said insert extends beyond said first end of each said arm when said inserts are secured within said jaws.

14. A tool as defined in claim 1, further including a plurality of inserts, each of which can be selectively inserted into and released from said cavities of said jaw portions.

15. A tool capable of operating in either a full cycle crimp mode or a cut/strip mode, said tool comprising:
first and second arms, each said arm having a jaw at one end thereof and a handle at an opposite end thereof;
a joint for connecting said first and second arms together, said joint being positioned between said jaws and said handles of said arms such that upon moving said handles toward one another, said jaws move toward one another;
a link having a plurality of teeth along an edge thereof, said link being connected to said handle of said first arm and to said handle of said second arm;
a pawl pivotally mounted on said handle of said first arm, said pawl capable of engaging said plurality of teeth on said link;
a spring connected to said pawl and to said handle of said first arm, said spring biasing said pawl toward said plurality of teeth on said link; and
means for changing the operation mode of said tool between the full cycle crimp mode and the cut/strip mode, said changing means capable of being in a first position where said tool is in the full cycle crimp mode and a second position where said tool is in the cut/strip mode, wherein in said first position said changing means forces said pawl to engage with said teeth of said link upon said handles being moved toward one another, and wherein in said second position said changing means being out of engagement with said teeth of said link upon said handles being moved toward one another.

16. A tool as defined in claim 15, wherein said changing means comprises a member provided on said handle of said first arm which is capable of sliding from said first position to said second position.

17. A tool as defined in claim 15, wherein said pawl is capable of engaging said teeth of said link, said pawl being capable of being engaged by said changing means, and said pawl being connected to said spring.

18. A tool as defined in claim 15, wherein said jaw of each said arm has a cavity formed therein.

19. A tool as defined in claim 18, further including a pair of inserts, one of said inserts capable of being inserted into said cavity of one of said jaws, said other insert capable of being inserted into said cavity of said other jaw, and means for releasably securing each said insert within said cavities of said jaws.

20. A tool as defined in claim 19, wherein each said releasably securing means comprises a stop at a first end of said cavity, a movable pin at a second end of said cavity, and a spring positioned against said movable pin to bias said movable pin toward said stop, wherein said insert is positioned within said cavity between said stop and said movable pin to releasably secure said insert within said cavity.

21. A tool as defined in claim 20, wherein said stop is a fixed pin.
